(19) United States
(12) Patent Application Publication
(10) Pub. No.: US 2023/0352777 A1
(43) Pub. Date: Nov. 2, 2023

(54) COVER STRUCTURE AND SMC MOLD, AND METHOD FOR PRODUCING SUCH A COVER STRUCTURE

(71) Applicant: Georg Fritzmeier GmbH & Co. KG, Aying (DE)

(72) Inventor: Stephan FRAUNHOFER, Aying (DE)

(21) Appl. No.: 17/796,590

(22) PCT Filed: Jan. 26, 2021
(86) PCT No.: PCT/EP2021/051675

§ 371 Date: Jul. 29, 2022

(30) Foreign Application Priority Data
Feb. 4, 2020 (DE) 102020102790.7
Mar. 19, 2020 (DE) 102020107675.4

(51) Int. Cl. H01M 50/143; H01M 50/164; H01M 50/159; H01M 50/16; B29C 70/18

(52) U.S. Cl. CPC H01M 50/143; H01M 50/164; H01M 50/159; H01M 50/16; B29C 70/18; B29L 2031/3468

(57) ABSTRACT

The invention relates to a cover structure, an SMC mold as well as a method for producing a cover structure having an SMC main body which is pressed together with a flame retardant coating in an SMC mold.

The invention relates to a cover structure, in particular for a battery, as well as to a sheet molding compound (SMC) mold, and a method for producing such a cover structure.

For some years now, there has been a trend toward replacing combustion engines with electric motors. One problem in this case is the provision of sufficient battery capacity. In particular, in the case of vehicles equipped with electric motors, batteries with a large capacity must be installed in order to ensure a satisfactory range. These are often mounted on the underbody of the vehicle, and must therefore be protected against external influences. Battery support structures of this type, realized with underride protection, are disclosed, for example, in DE 10 2011 005 403 A1 and in WO 2018/149762 A1.

In this context, as a rule, the batteries are accommodated in a type of battery box, by means of which the actual battery is protected toward the road by means of an underride protection. The part of the battery support structure, which is pointing to the body/vehicle cab, is covered by suitable cover structures. These must be designed in such a way that, in the event of a fire of the battery, they withstand the heat for a certain time, for example, for five minutes, so as to delay the spread of the fire to the vehicle cab and other vehicle components.

A battery box of this type, also known as a battery housing, is described in document DE 10 2010 043 899 A1. In this solution, a battery housing is formed with a housing cover, which is formed in accordance with an outer contour of a battery cell, and a housing base which is attached to the hood shaped housing cover. In the known solution, said battery housing is made out of a plastic material which is difficult to ignite.

Such a solution will not withstand prolonged heat generation.

In document DE 10 2013 220 778 A1 a battery housing made out of a plastic material is also being described which has the same disadvantages as the battery housing structure mentioned above.

In document DE 10 2009 050 787 A1, which is of an entirely different category, an aircraft component is being described, which is made out of a plastic material which is coated with a mica containing barrier layer in order to improve its fire behavior.

There are solutions known, in which the cover structures designed, for example, as battery box lids, are being manufactured as an SMC (sheet molded compound) component, and the required fire protection is then being achieved by subsequent adhesive bonding of a flame retardant layer, for example, of mica/micanite sheets.

Said approach requires a considerable expenditure with respect to manufacturing.

In contrast to that, the invention is based on the task of creating a cover structure which, on the one hand, is satisfying the fire protection requirements and, on the other hand, can be manufactured with reduced expenditure. In addition to that, the invention is based on the task of creating an SMC mold, which is suitable for producing such a cover structure, as well as a method for producing such a cover structure.

Said task is solved with regard to the cover structure by the combination of features of the patent claim 1, with regard to the SMC mold, by the features of the independent patent claim 13, and with regard to the method, by the combination of features of the further independent patent claim 15.

Advantageous further embodiments of the invention are the subject of the dependent patent claims.

The cover structure according to the invention is intended in particular for the use with a battery box wall, preferably a battery cover. Said cover structure has an SMC main body, which is made from an SMC blank, and is provided with a flame retardant coating. The latter is preferably formed from one or more molded part(s) and is pressed together with the SMC blank in an SMC mold.

In this way, the cover structure can be produced in a single operation, so that the manufacturing process is quite considerably simplified compared with the conventional solution which is involving the production of the SMC main body and the subsequent application of a flame retardant coating.

In a preferred embodiment of the invention, the flame retardant coating is realized with a perforation, which is made in accordance with a predetermined grid/pattern, wherein the openings of the flame retardant coating, which are being formed by the perforation, are designed in such a way that a plastic matrix of the SMC structure can pass through or at least enter said openings during the pressing together and the application of vacuum.

The plastic matrix, which is then entering the openings, enables a precise positioning of the location and connection between the molded part (flame retardant coating) and the SMC main body.

In addition to that, the perforation allows the vacuum to be formed through the same, so that the flame retardant coating is constituting a kind of sieve plate.

The connection can be further improved, if the openings have specifically manufactured unevennesses in their reveal surfaces which are designed in order to form a positive/non positive locking with the cured matrix.

Alternatively or in addition, burrs can be formed in the mouth area of these openings which are also designed in order to form a positive/non positive connection with the cured matrix.

In one solution, the at least one molded part of the flame retardant layer is realized with a connection layer which is designed to form a connection with the SMC main body and/or the SMC blank during the pressing together. The connection layer can be provided as an alternative or in addition to the positive/non positive locking via the openings or the mushroom fasteners.

Said connection is particularly easy to produce, if the connection layer is realized with a powder binder, which is melted/softened during the SMC pressing process at the usually elevated molding temperature and the vacuum applied, and thus is ensuring a reliable bond between the flame retardant coating and the SMC main body after curing.

The production of said molded part is particularly easy, if the connection layer is sinter-fused.

According to the invention, it is preferred, if the flame retardant coating is essentially formed from mica sheets/micanite sheets. In this connection, the flame retardant coating is preferably composed of a large number of such sheets.

In order to improve the electromagnetic compatibility (EMC) and thus in order to shield against other drive and adjustment/control elements of the vehicle, the cover structure can be realized with an EMC layer.

In a particularly simply constructed embodiment, said EMC layer is realized as an aluminum lamination which is covering the cover structure or the SMC main body.

The production is particularly easy, if the EMC layer/lamination, which is being realized in accordance with the geometry of the SMC main body, is adhesively bonded to the main body.

The adhesive bonding is preferably performed promptly after the demolding of the SMC main body, since it is then already heated to a suitable bonding temperature.

In particular in the automotive applications, it is preferred, if the EMC layer is applied to the side of the SMC main body which is facing away from the flame retardant coating.

An SMC mold, which is suitable for the production of a cover structure as it has been described above, has an upper mold and a lower mold, the molding surfaces of which together delimit a cavity for molding the cover structure, wherein it is possible for pockets to be formed in a molding surface, preferably in the molding surface of the lower mold, which pockets are aligned with the openings, and which are being covered in sections by a peripheral edge of the openings.

As a result of said covering, an overlapping is being formed during the pressing together, wherein the matrix is locally flowing behind said overlapping, and thus is forming a kind of mushroom fastener which is contributing to the precise positional fixing of the flame retardant coating with respect to the SMC main body. During the pressing together, the flame retardant coating is being pressed against the molding surfaces of the mold as a result of the flow pressure of the matrix, so that a slipping prior to the formation of the mushroom fasteners, which have been mentioned above, is being prevented.

Preferably, said covering is realized to be larger than the wall thickness of the flame retardant coating.

In accordance with the method of the invention for the production of such a cover structure, the at least one, preferably a large number, of molded parts, which are forming the flame retardant coating, are inserted into an SMC mold, in particular are being positioned on the molding surface of the lower mold. Prior to or after said insertion of the molded parts, the SMC blank (also called SMC package) is being positioned in the mold, and subsequently, by closing the mold halves (upper mold/lower mold) and applying a vacuum, the SMC blank is being pressed together with the molded parts, which are forming the flame retardant coating, in order to form the cover structure and/or an SMC main body.

The applicant reserves the right to direct separate independent patent claims to the variants for the positional fixing of the flame retardant coating relative to the SMC main body/SMC blank with the formation of the perforation and/or the mushroom fasteners and/or the molded parts which are being realized with a connection layer.

In the case of an alternative solution, the flame retardant coating and the EMC layer are adhesively being bonded together to the SCM main body in a single operation. This can be done, for example, in an adhesive tool into which the SMC main body, the flame retardant coating (mica sheet) and the EMC layer (formed aluminum foil) are being inserted. The applicant reserves the right to direct a separate independent patent claim to said alternative.

Preferred embodiments of the invention are explained in more detail below with reference to the schematic drawings. They show:

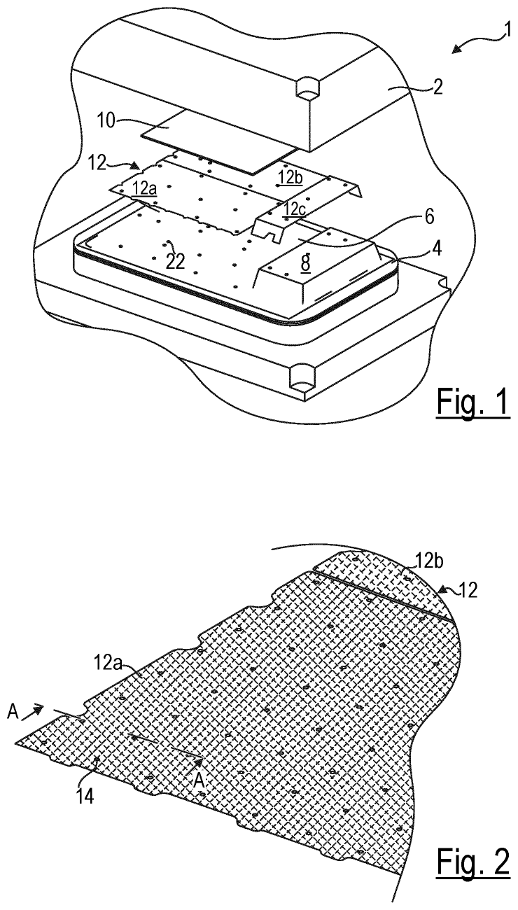

FIG. 1 is a schematic diagram of an open SMC mold with an SMC blank and a flame retardant coating in accordance with a first embodiment;

FIG. 2 is a detailed representation of an area of the flame retardant coating in accordance with a second embodiment;

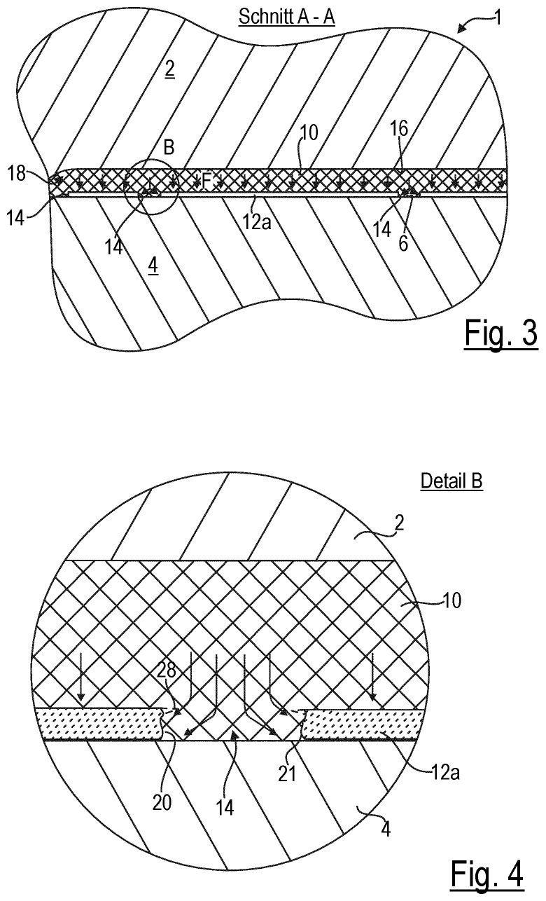

FIG. 3 is a section through a cover structure when pressing together the components in accordance with FIG. 2;

FIG. 4 is a detail B from FIG. 3;

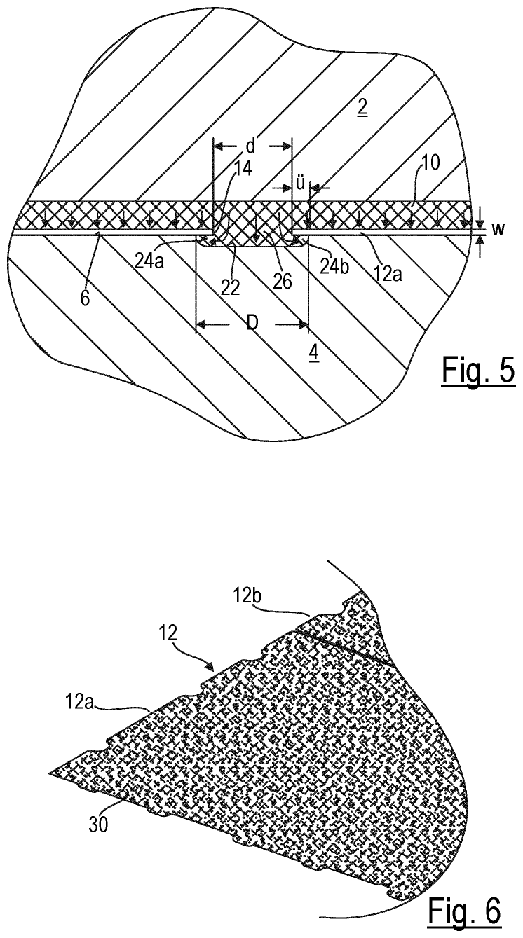

FIG. 5 is a representation of the first embodiment in accordance with FIG. 4 in which a mushroom fastener is formed;

FIG. 6 is a third embodiment in which the flame retardant coating is realized with a connection layer;

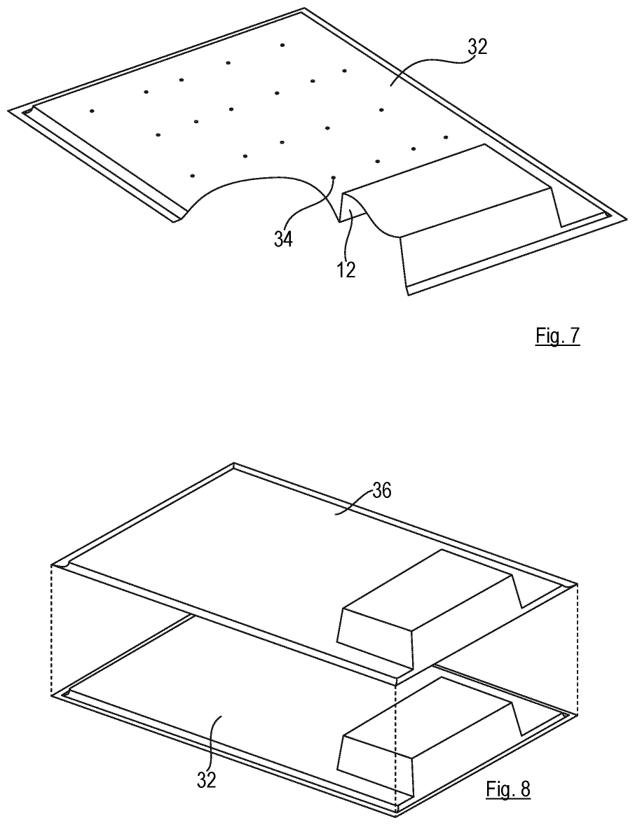

FIG. 7 is a cover structure after demolding from the SMC mold;

FIG. 8 is a schematic diagram of an operational step during which an EMC layer is being applied on the cover structure in accordance with FIG. 7;

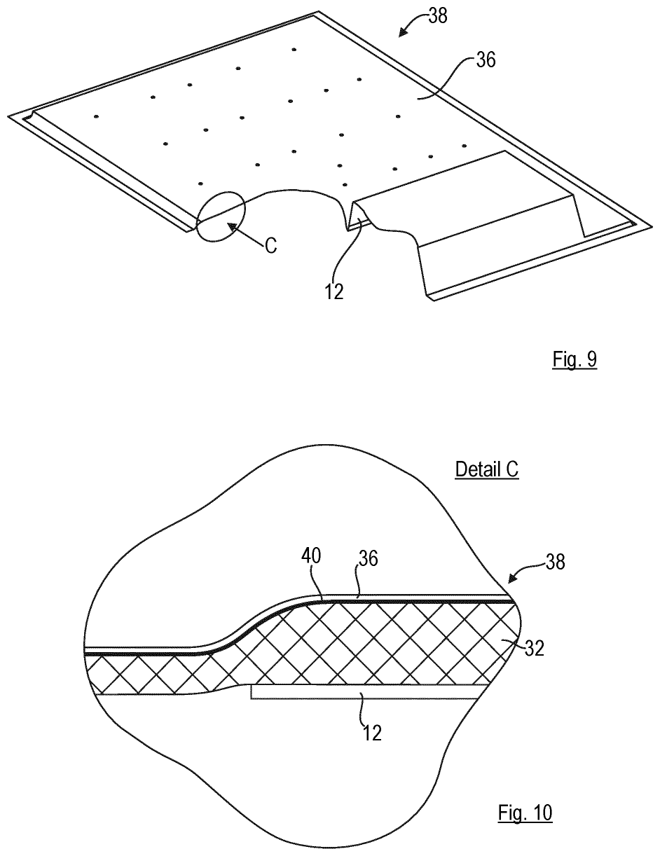

FIG. 9 is a representation of a cover structure which has been realized with the EMC coating and

FIG. 10 is the detail C from FIG. 9.

FIG. 1 shows the basic structure of an SMC production unit with an SMC mold 1, which is being operated by an SMC press not shown, with an upper mold 2 and a lower mold 4 which are moved apart from one another in the representation in accordance with FIG. 1. The molding surfaces 6, 16 (see FIG. 3) are being formed in the lower mold 4 (and correspondingly also in the upper mold 2) which, in the closed state, form a cavity for molding a cover structure of a battery box. Said cover structure, for example, a battery lid, is shown in FIG. 7, to which we will return later. The molding surfaces 6, 16 are formed as 3D surfaces in accordance with the geometry of said cover structure. In the embodiment shown, the molding surface 6 is bulging upward in the area on the right in FIG. 1, toward the upper mold 2, so that a bulge 8 is formed which, in the assembled state, is covering a component of the vehicle, for example, a tank or the like. A corresponding indentation is then provided in the upper mold part 2, so that a hood is being formed when the SMC tool 1 is closed.

An SMC blank 10 as well as a flame retardant coating 12 are being inserted into the opened SMC mold 1. In the embodiment shown, the flame retardant coating 12 is formed of mica sheets 12a, 12b, 12c in several parts which are placed onto the molding surface 6 in the embodiment shown. In this case, the mica sheet 12c is covering the bulge 8 which is forming the hood. Accordingly, the mica sheets 12a, 12b, 12c are formed in accordance with the contour of the molding surfaces 6 and/or the cover structure to be formed.

The SMC blank 10 consists, for example, of a fiber mat, fiber fleece or the like, which is being surrounded by a plastic matrix, such as, for example, a polyester or a vinyl ester resin, which then melts during the pressing together and the application of vacuum in the SMC mold 1 heated to the forming/melting temperature, so that the SMC blank 10 can be formed into the predetermined geometry of the SMC main body 32, and retains said 3D geometry after curing/demolding.

Not shown in FIG. 1 are other components/insertion parts, which are being introduced into the SMC mold 1, and via which the cover structure can be mounted, for example, on the battery box or the like.

As far as further details with respect to the SMC method are concerned, reference is made to the extensive technical literature, so that only the details, which are essential for the understanding of the invention, need be discussed here.

FIG. 2 shows a partial representation of a second embodiment of mica sheets 12a, 12b of the flame retardant coating 12, for which a spacing of openings 14 is realized somewhat narrower than in FIG. 1—this will still be discussed later. As it has been explained above, the mica sheets 12a, 12b are formed in accordance with the contour of the molding surface 6 and/or the cover structure, and are covering the areas of the cover structure which are at risk in the event of heat generation. In the embodiment shown, the mica sheets 12a, 12b, 12c are provided with a perforation, which is formed by the openings 14 mentioned above, and which penetrate the sheet like material of the mica sheets 12a, 12b, 12c in accordance with a predetermined grid. Said openings 14 are formed in such a way that, when the layers are being pressed together, the plastic matrix can enter into said openings 14. In this connection, the mica sheets 12a, 12b, 12c are pressed and pulled against the molding surface 6 by the flow pressure and also by the vacuum applied, and are thus reliably fixed in position. In FIG. 2, a line of intersection A-A is being drawn which roughly shows the course of the section through the structure which is being shown in FIG. 3.

FIG. 3 shows a partial representation of the SMC mold 1 during the pressing together. Accordingly, the upper mold 2 and the lower mold 4 are moved into the closed position, in order that the molding surface 6 of the lower mold 4 and a molding surface 16 of the upper mold 2 are forming the cavity 18 mentioned above, into which the SMC blank 10 and the flame retardant coating 12 with the mica sheets 12a, 12b, 12c etc. are accommodated. In said representation, two of the openings 14 of the mica sheet 12a can be seen. During the pressing together (closing of the mold 1, application of vacuum and temperature increase), the mica sheets 12a, 12b, 12c are pressed against the molding surface 6 by the flow forces F, as it has been mentioned above. The plastic matrix melted during the pressing together, is subsequently flowing into the openings 14, as it is being shown by the double arrows.

As it is being shown in the detail B of FIG. 4, the reveal 20 of each opening 14 of the flame retardant coating 12 is not smooth surfaced, but is formed with deliberately formed unevennesses 21, for example, grooves or elevations, into which the plastic matrix is flowing, and thus is forming local undercuts which, during the curing of the plastic matrix, make sure that the SMC main body 32, which is formed from the SCM blank 10, is positively and non positively connected to the flame retardant coating 12. Said entering of the plastic matrix into the area of the openings 14 contributes to the further relative positioning of the mica sheets 12a, 12b, 12c with respect to the SMC blank 10 (SMC package).

In FIG. 5 an alternative is being shown, in which said relative positioning between the mica sheets 12a, 12b, 12c and the SMC blank 10 is still further improved. In said first embodiment, pockets 22 are formed in the molding surface 6 which are aligned with respect to the openings 14. Accordingly, the grid of the pockets 22 on the molding surface 6, which is shown in FIG. 1, is formed in accordance with the grid of the perforation of the flame retardant coating 12. However, the width or the diameter D of the pockets 22 is formed to be larger than the width/the diameter d of the openings 14, so that, if the grids are formed in an identical manner, the edge regions of the openings 14 are covering the pocket 22 in sections.

As it is shown in FIG. 5, the covering ü is designed to be larger than the wall thickness w of the flame retardant coating 12 and/or the mica sheets 12a, 12b, 12c.

Accordingly, an undercut 24a, 24b is being formed, into which the plastic matrix is flowing during the pressing together, thus forming a kind of mushroom fastener 26 by means of which the mica sheets 12a, 12b, 12c and the SMC blank 10 and/or the SMC main body 32 are positively/non positively connected to each other after curing.

In order to further improve the connection between the SMC main body 32 and the flame retardant coating 12, the reveals 20 of the openings 14 may also be realized with the unevennesses 21.

As a result of the design of the mushroom fasteners 26, it is possible to realize the grid of the openings 14 in the first embodiment in accordance with FIG. 5 to be larger (see also FIG. 1) than the grid of the openings 14 in the second embodiment in accordance with FIGS. 2 and 3, since there only the comparatively small unevennesses 21 are forming the positive locking. Said positive locking can still be further improved if, alternatively or in addition, burrs 28 or the like, which are forming undercuts, are also formed in the region of the peripheral edge of each opening 14. Said burrs 28 are indicated by dashed lines in FIG. 4.

The formation of the pockets 22 in the molding surfaces 6 or 16 of the lower mold 4 and/or the upper mold 2 and/or the openings 14 in the flame retardant coating 12 is relatively complex to realize. The expenditure with respect to apparatus complexity and the expenditure with respect to the production can be reduced in accordance with FIG. 6, if the flame retardant coating 12, in the third embodiment shown, the mica sheets 12a, 12b, 12c, are provided with a powder binder 30. This can be a sinter-fused powder binder 30, the material of which is selected in such a way that it is melted during the pressing together due to the increased mold temperature and the vacuum in the cavity 18, and thus is forming an intimate connection with the SMC main body 32 and/or the SMC blank 10. Accordingly, said powder binder 30 is formed on the large surface of the flame retardant coating 12 pointing to the SMC blank 10.

The advantage of the above-described embodiments is the fact that the SMC main body 32, which is being shown in FIG. 7, can be formed as a complex 3D structure with the flame retardant coating 12—in the present case the mica sheets 12a, 12b, 12c-in a one step process. By said pressing together in the SMC mold 1, components inserted into the SMC blank 10 (SMC package) or into the cavity 18, such as, for example, fastening bushings 34, are also integrated into the SMC structure and/or into the cover structure without any additional machining being required. In this way, even for large battery capacities, the single step process can be used to produce suitable dimensionally stable covers, which meet fire protection regulations and which can have an area of significantly more than 1 m².

In order to improve the EMC, an EMC layer (lamination) can be applied to the SMC main body 32, which is shown in FIG. 7, on the large surface facing away from the flame retardant coating. In the embodiment shown, said EMC layer is formed from an aluminum foil/aluminium lamination 36 which is formed in a forming tool in accordance with the 3D geometry of the SMC main body 32. Said aluminum foil 36 is then provided with an adhesive layer on the large surface facing the SMC main body 32.

In a subsequent operation, the SMC main body 32, which is pressed together with the flame retardant coating 12, is demolded from the SMC mold 1, and transferred at the demolding temperature to a bonding press or any other bonding tool, the aluminum foil 36 is applied and then pressed together with the SMC main body 32, so that after said operation a cover structure 38 is formed, for example, a battery lid of a battery box, which is provided with the EMC layer toward the vehicle cabin, and with the flame retardant coating 12 toward the battery.

FIG. 10 is showing the detail C in FIG. 9, that means, the layered structure of the cover structure 38 with the aluminum foil 36 placed at the top (view in accordance with FIG. 10), which is flatly connected to the SMC main body 32 via an adhesive joint 40. Said SMC main body 21 is in turn positively/non positively connected, in the manner described above, with the flame retardant coating 12, for example, the mica sheets 12a, 12b, 12c, so that a homogeneous layered structure is ensured which is optimized with regard to the EMC problem, the fire protection resistance and the mechanical strength.

The invention relates to a cover structure, an SMC mold as well as a method for producing a cover structure having an SMC main body which is pressed together with a flame retardant coating in an SMC mold.

### LIST OF REFERENCE NUMERALS

1 SMC mold
2 upper mold
4 lower mold
6 molding surface
8 bulge
10 SMC blank
12 flame retardant coating
12a mica sheet
12b mica sheet
12c mica sheet
14 opening
16 molding surface
18 cavity
20 reveal
21 unevenness
22 pocket
24 undercut
26 mushroom fastener
28 burr
30 powder binder
32 SMC main body
34 fastening bushing
36 aluminium foil/aluminium lamination
38 cover structure
40 adhesive joint

1. A cover structure, in particular for a battery, having an SMC main body provided with a flame retardant coating, wherein the flame retardant coating realized from at least one molded part and an SMC blank forming the SMC main body are pressed together in an SMC mold, wherein the flame retardant coating has a perforation in accordance with a predetermined grid, wherein openings formed by the perforation are designed in such a way that a plastic matrix of the SMC blank can pass through or enter said openings during the pressing together.

2. The cover structure according to claim 1, wherein the openings in their reveal comprise unevennesses which are designed to form a positive/non positive locking with the cured plastic matrix.

3. The cover structure according to claim 1, wherein burrs are formed in a peripheral region of the openings which are designed to form a positive/non positive locking with the cured matrix.

4. The cover structure according to claim 1 wherein the molded part forming the flame retardant coating is provided with a connection layer which is designed to form a connection with the SMC main body and/or the SMC blank during the pressing together.

5. The cover structure according to claim 4, wherein the connection layer is a powder binder which is designed to be melted or softened in the SMC mold.

6. The cover structure according to claim 4, wherein the connection layer is sinter-fused.

7. The cover structure according to claim 1, wherein the flame retardant coating is essentially formed from mica sheets.

8. The cover structure according to claim 1 with an EMC layer.

9. The cover structure according to claim 8, wherein the EMC layer is an aluminium lamination.

10. The cover structure according to claim 8, wherein the EMC layer is adhesively bonded to the SMC main body.

11. The cover structure according to claim 8, wherein the EMC layer is disposed on the large surface of the SMC main body facing away from the flame retardant coating.

12. Arrangement of an SMC mold for producing and in combination with an SMC cover structure according to claim 1 with an upper mold and a lower mold, the molding surfaces of which together delimit a cavity for molding an SMC main body, wherein in a molding surface, pockets aligned with the openings are formed, which are covered in sections by a peripheral edge of the openings.

13. The Arrangement according to claim 12, wherein the covering is larger than the wall thickness of the flame retardant coating.

14. A method for producing a cover structure according to claim 1 with the following steps:
insertion of molded parts forming a flame retardant coating into an SMC mold, wherein the flame retardant coating is adjacent to a lower mold or an upper mold,
insertion of an SMC blank into the SMC mold, and
pressing together the SMC blank with the flame retardant coating to form an SMC main body, wherein openings of the flame retardant coating and pockets in a molding surface are aligned in such a way that a plastic matrix of the SMC blank passes through the openings and into the pockets during the pressing together.

15. The method for producing a cover structure according to claim 14, with the step of:
application of an EMC layer on the SMC main body.

16. The method for producing a cover structure according to claim 15, wherein the application is an adhesive bonding which is performed promptly after the demolding of the SMC main body from the SMC mold.
